(19) United States
(12) Patent Application Publication
(10) Pub. No.: US 2009/0024408 A1
(43) Pub. Date: Jan. 22, 2009

(54) GOAL DRIVEN EXCEPTION MANAGEMENT AND ACTIONABLE RECOMMENDATION SYSTEM FOR RETAILER AND SUPPLIER APPLICATIONS

(75) Inventors: Dejia Wang, San Mateo, CA (US); Suresh Kuppahally, Saratoga, CA (US); Jie Weng, Sunnyvale, CA (US); Calvin Lee, San Francisco, CA (US); Li Chen, Cupertino, CA (US)

Correspondence Address: FISH & RICHARDSON P.C., PO BOX 1022, MINNEAPOLIS, MN, 55440-1022, US

(73) Assignee: TRUEDEMAND SOFTWARE, INC., Los Gatos, CA (US)

(21) Appl. No.: 12/176,223

(22) Filed: Jul. 18, 2008

Related U.S. Application Data
(60) Provisional application No. 60/950,585, filed on Jul. 18, 2007.

(51) Int. Cl. G06Q 10/00; G06N 5/02

(52) U.S. Cl. 705/1; 706/47

(57) ABSTRACT

Methods, systems, and apparatus, including computer program products, for providing recommendations in a retail environment. A recommendation system includes a centralized knowledge base including one or more rules for defining logic to provide recommendations based on one or more detected system alerts, an alert engine for determining alert conditions in a retail presence including out of stock conditions, a root cause engine for determining one or more root causes for out of stock conditions that are detected, a mapping engine for mapping between alerts and recommendations, and a recommendation engine for issuing one or more recommendations associated with given alerts and determined root causes.

### RELATED APPLICATIONS

This application claims the benefit under 35 U.S.C. § 119 of U.S. Provisional Application No. 60/950,585, titled “A Goal Driven Exception Management and Actionable Recommendation System for Retailer and Supplier Applications,” filed Jul. 18, 2007, which is incorporated by reference herein in its entirety.

### BACKGROUND

This specification is generally related to retailer management.

Management of a retailer and its suppliers involves making many decisions. Decisions can be made for the sake of moving the retailer and its suppliers toward particular business goals, solve problems, or to prevent future occurrences of particular problems. The decisions can be made based on business data generated by the retailer and its suppliers, however, the retailer and its suppliers can generate an enormous amount of business data. Analyzing the data and determining the proper course of action can be a daunting task.

### SUMMARY

In general, one aspect of the subject matter described in this specification can be embodied in systems, apparatus, methods and computer program products for goal driven exception management and actionable recommendations for retailer and supplier applications. An example system can include a centralized knowledge base including one or more rules for defining logic to provide recommendations based on one or more detected system alerts, an alert engine for determining alert conditions in a retail presence including out of stock conditions, a root cause engine for determining one or more root causes for out of stock conditions that are detected, a mapping engine for mapping between alerts and recommendations, and a recommendation engine for issuing one or more recommendations associated with given alerts and determined root causes. Other embodiments of this aspect include corresponding methods, apparatus, computer program products, and computer readable media.

Particular embodiments of the subject matter described in this specification can be implemented to realize one or more of the following advantages. Business logic for providing recommendations to problems is easier to understand and easier to maintain.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual diagram of an example goal-driven management system.

FIG. 2 is a block diagram illustrating a system architecture for an example goal-driven management system.

Like reference numbers and designations in the various drawings indicate like elements.

### DETAILED DESCRIPTION

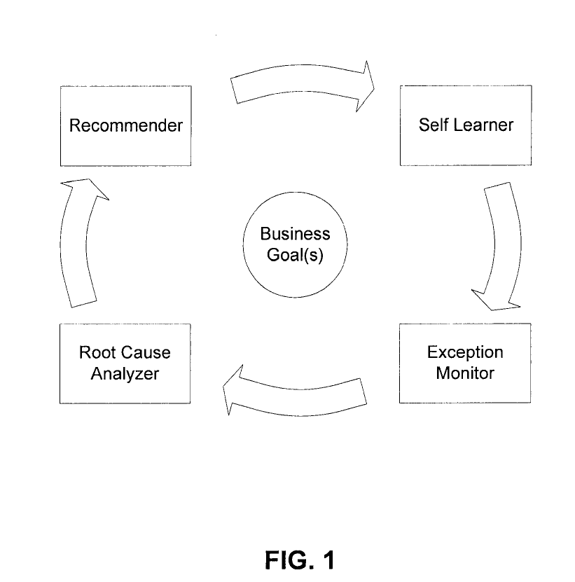

FIG. 1 is a conceptual diagram 100 of an example goal-driven management system. As shown FIG. 1, a goal-driven management system can allow use of rule engine technology to define business goals for an entity and its relationships (e.g., a retailer and its suppliers), monitor business exceptions, analyze root causes and generate actionable recommendations. In some implementations, the system monitors performance indicators and event status, and based on the monitoring, generate alerts of problem occurrences, problem persistency, and problem frequencies. In some implementations, the system also assists in the determination of, e.g., in real-time, necessary actions to address and resolve problem situations or to prevent such problems from occurring in the future. In some implementations, the system also self-learns and self-tunes to improve its recommendation accuracy.

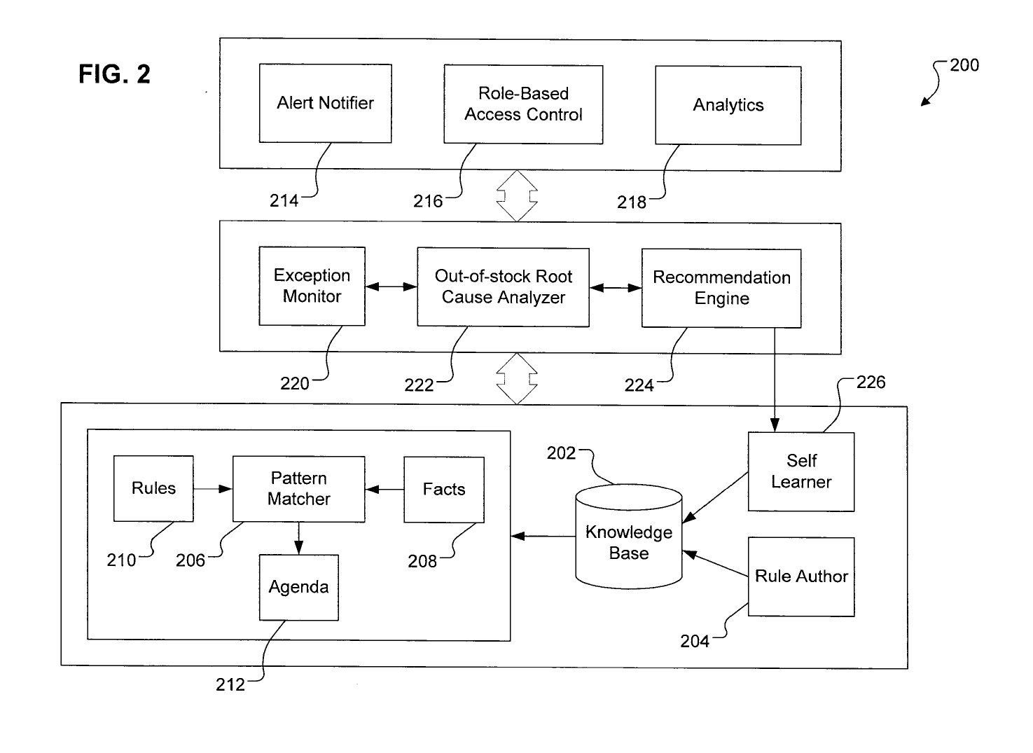

FIG. 2 is a block diagram illustrating a system architecture 200 for an example goal-driven management system. The system 200 includes a centralized knowledge base 202. The knowledge base 202 can be executable. Plan or business goals, metric thresholds, and business logics can be declared in the knowledge base 202. Metrics can be in the form of domain objects, and the business logic can be in the form of rules. The knowledge base 202 can include models of problems (e.g., in a retail and supplier context) and solutions to the problems. The knowledge base 202 can be implemented using rules. In some implementations, the solutions to the problems are expressed as rules. By creating object models (and optionally domain specific languages) that model a problem domain, the rules can resemble natural language. The knowledge base 202 provides a single point of truth, and can be accessible and readable using, for example, rule templates, domain specific language(s), and spreadsheets. Rules can be authored for the knowledge base 202 using a rule author 204.

In some implementations, the rules in the knowledge base 202 are defined using templates. Examples of rules can include alert rules and recommendation rules. An alert rule can define an alert condition and the alert to be raised for that condition. A recommendation rule can define a solution or recommendation for a particular condition or problem (e.g., an alert condition). Alert and recommendation rules can be classified by alert and recommendation types. Different rule templates can be used for different alert and recommendation types. In some implementations, such rules can be parameterized. In some implementations, the templates for the alert and recommendation rules provide the capability to customize rule parameters (add/remove/delete) as well as changing the logic in the templates. The templates can be created or modified using the rule author 204.

Recommendations can be generated for addressing issues and alerts. An alert notifier 214 can generate the alert notifications to be presented to users (e.g., retailer and supplier personnel). The recommendations can be generated by a recommendation engine 224. A recommendation can address one or more issues (e.g., root causes for OOS conditions) or alerts, and an issue or alert can generate one or more recommendations. In some implementations, there is a many-to-many relationship between alert/issue definitions and recommendation types.

System 200 can include an exception monitor 220 for monitoring business exceptions, an out-of-stock root cause analyzer 222 for determining root causes of out-of-stock conditions, a self-learner 226 for learning from generated recommendations and making adjustments to the knowledge base 202 and the rules based on the learning, and analytics system 218 for analyzing business data.

The system 200 can provide recommendation reasoning traceability. For example, system 200 can be configured to provide a solution that is able to explain why a “decision” was made. The system 200 can be configured to provide a mechanism (e.g., recommendation engine 224) to trace back the reasons for a particular recommendation. The recommendation engine 224 can determine which recommendation rule generated a particular recommendation. Recommendation reasoning traceability provides a way to increase recommendation accuracy and confidence.

In some implementations, the system 200 evaluates data metrics at different levels and these levels form a hierarchy (e.g., plan level->product level, location level->product/location level). At each level, the system 200 can use different criteria to evaluate alerts, issues, and recommendations. The system 200 can provide the capability to customize the thresholds at different levels, as well as requiring a threshold at each level. The system 200 can also support default alert and recommendation rule parameters.

System 200 can include a business rules framework (BRF), which can be configured to support uniform rule authoring, deployment and execution. The BRF can be configured to support unique alert and recommendation life-cycle management. In some implementations, a generated alert or recommendation has its own life-cycle. A newly created recommendation get receive a measure of attention. The recommendation can expire when the condition is no longer valid. System 200 can maintain a history of alerts and recommendations to support data analytics and self-learning. System 200 can adjust user inputs and system thresholds according to plan goal achievement, problem occurrences, persistency, frequencies, and system feedback.

The system 200 can include a pattern matcher 206. The pattern matcher 206 can take in facts 208 (e.g., retail data) and rules 210 (e.g., rules from knowledge base 202). The pattern matcher 206 can apply the rules to the facts to generate an agenda 212 (e.g., alerts, recommendations, etc.).

Pattern matcher 206 can use enhanced traditional rule pattern matching algorithms for speed and scalability. For example the pattern matcher 206 can employ the Rete algorithm and the Leaps algorithm (and their variants) to match rule patterns to domain object data. These algorithms are especially efficient when the system includes datasets that do not change entirely (as the rule engine can remember past matches).

The system 200 can support selective Stock Keeping Unit (SKU)-location-(sub)date level alert monitoring and recommendation generation. Recommendations can be given at SKU-location-(sub)date level based on the data metrics provided at SKU-location-(sub)date. Due to the large number of SKU and location combinations, the system 200 can include a capability to generate alerts and recommendations for a filtered subset of SKU and location combinations. In some implementations, filter conditions can be based on (a) whether there are any alerts/issues at the plan/product level and/or (b) whether the product and location combination is a valid-traited combination. The recommendation can be given within the context of a plan, e.g., a plan that is goal driven. Even though the system 200 can generate recommendations at a SKU-location-(sub)date level, the recommendation model itself is not required to be tied to any particular level.

The system 200 can support role-based recommendation visibility. In order to not expose too many recommendations to all application end users, the system 200 can provide a mechanism (e.g., role-based access control 216) to deliver localizable recommendations to the relevant people and/or systems at the right time. The system 200 can also support actionable recommendation details to guide user actions.

System 200 can perform a process for issuing recommendations. For example, the process can include identifying or providing one or more rules for defining logic to provide recommendations based on one or more detected system alerts. Alert conditions in a retail presence are determined, including detecting out-of-stock conditions. One or more root causes for the detected out-of-stock conditions are detected. Mapping between the detected alerts and/or root causes and recommendations is performed. One or more recommendations associated with the given alerts and determined root causes are issued. In some implementations, the process can further include using the determined alert conditions and root causes and the issued recommendations to self-learn and to adjust the rules.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a centralized knowledge base including one or more rules for defining logic to provide recommendations based on one or more detected system alerts;
an alert engine for determining alert conditions in a retail presence including out of stock conditions;
a root cause engine for determining one or more root causes for out of stock conditions that are detected;
a mapping engine for mapping between alerts and recommendations; and
a recommendation engine for issuing one or more recommendations associated with given alerts and determined root causes.

2. The system of claim 1, wherein a recommendation addresses one or more issues related to an alert or a root cause, and wherein an issue related to an alert or a root cause generates one or more recommendations.

3. The system of claim 1, wherein the recommendation engine is operable to evaluate data metrics at one or more different levels, the one or more levels forming a hierarchy.

4. The system of claim 3, wherein at each level, the recommendation engine uses different criteria to evaluate alerts and recommendations.

5. The system of claim 1, wherein the centralized knowledge base includes a business rules framework (BRF) configured to support uniform rule authoring, deployment and execution.

6. The system of claim 5, wherein the BRF is configured to support unique alert and recommendation life-cycle management.

7. The system of claim 6, wherein a generated alert or recommendation has its own life-cycle.

8. The system of claim 1, wherein the recommendation engine provides recommendation reasoning traceability

9. A method comprising:
providing one or more rules for defining logic to provide recommendations based on one or more detected system alerts;
determining alert conditions in a retail presence including out of stock conditions;
determining one or more root causes for detected out of stock conditions;
mapping between alerts and recommendations; and
issuing one or more recommendations associated with given alerts and determined root causes.
